(19) United States
(12) Patent Application Publication
(10) Pub. No.: US 2018/0004441 A1
(43) Pub. Date: Jan. 4, 2018

(54) INFORMATION PROCESSING APPARATUS, COMPUTER-READABLE RECORDING MEDIUM HAVING STORAGE CONTROL PROGRAM STORED THEREIN, AND METHOD OF CONTROLLING STORAGE

(71) Applicant: FUJITSU LIMITED, Kawasaki-shi (JP)

(72) Inventors: Tatsushi TAKAMURA, Sagamihara (JP); Tsuyoshi HASHIMOTO, Kawasaki (JP)

(73) Assignee: FUJITSU LIMITED, Kawasaki-shi (JP)

(21) Appl. No.: 15/496,669

(22) Filed: Apr. 25, 2017

(30) Foreign Application Priority Data
Jun. 30, 2016 (JP) 2016-129707

(51) Int. Cl. G06F 3/06

(52) U.S. Cl. CPC G06F 3/0619; G06F 3/0685; G06F 3/0643; G06F 3/0647; G06F 3/065

(57) ABSTRACT

An information processing apparatus includes a memory and a first processor and a second processor coupled to the memory. The first processor is configured to manage files in a storage apparatus and accesses to the files; and determine a migration target file from the files based on a history of the accesses to the files, the migration target file being to be migrated from a second storage medium to a first storage medium in the storage apparatus, the first and second storage mediums having different performances. The second processor is configured to control migrations of the files between the first storage medium and the second storage medium; and migrate the migration target file from the second storage medium to the first storage medium.

### CROSS-REFERENCE TO RELATED APPLICATION

This application is based upon and claims the benefit of priority of the prior Japanese Application No. 2016-129707 filed on Jun. 30, 2016 in Japan, the entire contents of which are hereby incorporated by reference.

### FIELD

The embodiment discussed therein relates to an information processing apparatus, a computer-readable recording medium having a storage control program stored therein, and a method of controlling a storage.

### BACKGROUND

The hierarchical storage management (hereinafter referred to as “HSM”) is one technique to place files one of a set of relatively slower, larger-capacity, and less expensive secondary storage media and a set of relatively faster, smaller-capacity, and expensive primary storage media, depending on how frequently the files are used. It is possible to maximize the system performance per maintenance cost for storage media can be by changing the placements of files depending on how frequently the files are used (access frequency).

Upon implementing a typical HSM, data blocks (files) are migrated between storage media of two different types with different performances, in response to the following triggers [a1] and [a2], for example. Here, one of the storage media of the two types is a primary storage medium as described above, and is a storage class memory (SCM) or a solid state drive (SSD), for example. The other of the storage media of the two types is a secondary storage medium as described above, and is a hard disk drive (HDD), for example.

[a1] In response to an access request to a data block on the secondary storage medium, the data is migrated from the secondary storage medium to the primary storage medium, for increasing the access speeds of subsequent accesses.

[a2] When no access request has been made to a data block on the primary storage medium for a predetermined time duration or longer, that data block is migrated from the primary storage medium to the secondary storage medium. Alternatively, when the free space in the primary storage medium becomes equal to or less than a predetermined threshold, data blocks are migrated from the primary storage medium to the secondary storage medium, in the descending order of the lengths of no access time of the data blocks. Note that data blocks may be migrated from the primary storage medium to the secondary storage medium at both of the two timing.

Patent Document 1: Japanese Laid-open Patent Publication No. 2005-157711

Patent Document 2: Japanese Laid-open Patent Publication No. 2006-260067

Patent Document 3: Japanese Laid-open Patent Publication No. 2015-141545

Patent Document 4: Japanese Laid-open Patent

Publication No. 2008-41020

In the meantime, in a typical HSM technique, file migrations between media are controlled based on access states of files in a certain time span of the predetermined duration from the past to the present. Therefore, it is difficult to implement a read-ahead of a “file that has not been accessed for a long”. As a result, upon accessing the “file that has not been accessed for a long”, some delay induced by a data migration from a slower secondary storage medium to a faster primary storage medium is inevitable.

Specifically, in an on-demand control as depicted in FIG. 10, when transfer processing for migrating a target file to a primary storage medium is initiated, which is triggered by reception of an access request to the file in a secondary storage medium, a relative long latency of calculation processing arises due to waiting time until the completion of the transfer processing. Hence, in order to overcome the limit of the performance of the on-demand control, a prediction of an access to a file that has not been accessed for a predetermined time duration or longer and a file migration between storage media are essential.

In existing techniques that predict accesses to files and to read-ahead the files (refer to Patent Documents 1-4), however, obtainment of accurate information on a definite schedule and file access characteristics of each file, and detailed information, such as operation timing of programs, are indispensable. However, obtaining detailed information is particularly time-consuming, and accordingly making predictions of accesses to files is cumbersome. Therefore, there is a need for an HSM technique that can easily make predictions of accesses to files, without requiring detailed information as described above.

### SUMMARY

An information processing apparatus of the present disclosure includes a memory and a first processor and a second processor coupled to the memory. The first processor is configured to manage files in a storage apparatus and accesses to the files; and determine a migration target file from the files based on a history of the accesses to the files, the migration target file being to be migrated from a second storage medium to a first storage medium in the storage apparatus, the first and second storage mediums having different performances. The second processor is configured to control migrations of the files between the first storage medium and the second storage medium; and migrate the migration target file from the second storage medium to the first storage medium.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram depicting an example of a hardware configuration of an information processing apparatus of a present embodiment;

FIG. 2 is a block diagram depicting an example of a functional configuration of the information processing apparatus of the present embodiment;

FIG. 3 is a flowchart illustrating collection and accumulation operations of the information processing apparatus of the present embodiment access history;

FIG. 4 is a flowchart illustrating a file management operation and a storage control operation of the information processing apparatus of the present embodiment;

FIG. 5 is a diagram depicting an example of the definition of a record in a file access history log file accumulated as an access history in the present embodiment;

FIG. 6 is a diagram illustrating how an access state database is generated in the present embodiment;

FIG. 7 is a flowchart illustrating a generation operation of an access state database in the present embodiment;

FIG. 8 is a diagram depicting one example of control sentences for calculating access probabilities in the present embodiment;

FIG. 9 is a diagram depicting another example of control sentence for calculating access probabilities in the present embodiment;

FIG. 10 is a diagram illustrating latencies of computation processing experienced in existing techniques; and

FIG. 11 is a diagram illustrating latencies of computation processing experienced in the present embodiment.

### DESCRIPTION OF THE PREFERRED EMBODIMENTS

Details of an embodiment of an information processing apparatus, a storage control program, and a method of controlling a storage disclosed herein will be described with reference to the drawings. The embodiments described below are merely exemplary, and it is not intended to exclude various modifications and applications of techniques that will not be described explicitly. In other words, the present embodiment may be practiced in a various modifications without departing from the spirit thereof. It is not intended that only configuration elements depicted in the drawings are provided, and other functions may also be included. The embodiments may be combined in a suitable manner in the extent where no contradiction arises.

In the drawings described below, elements denoted by the like reference symbols refer to the same or similar elements, unless otherwise stated.

(1) Hardware Configuration of Information Processing Apparatus of Present Embodiment

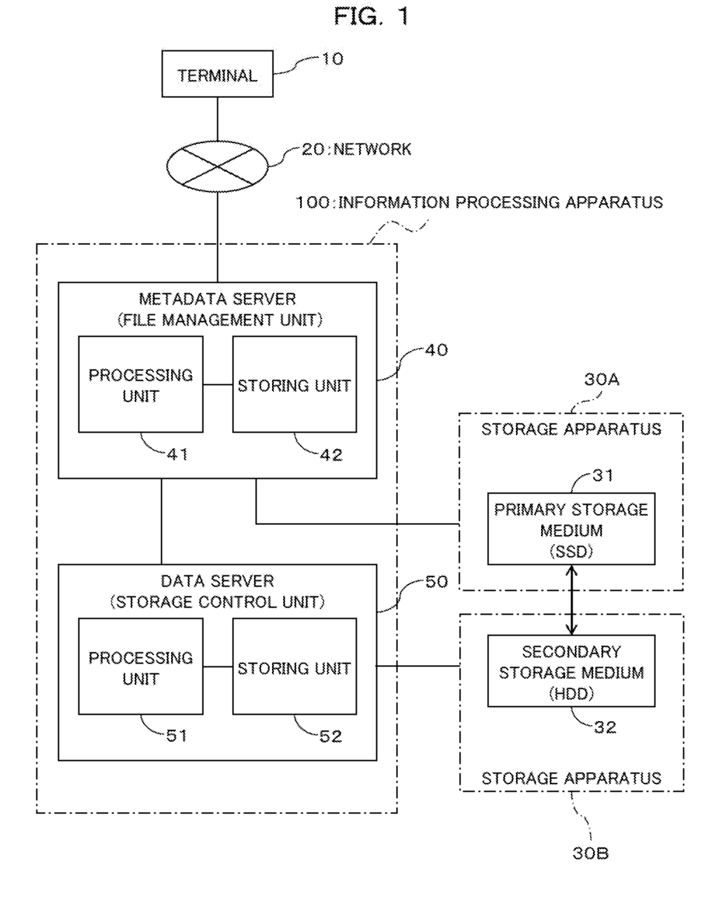

Initially, referring to FIG. 1, a hardware configuration of an information processing apparatus 100 of the present embodiment will be described. FIG. 1 is a block diagram depicting an example of a hardware configuration of the information processing apparatus 100 of the present embodiment.

As depicted in FIG. 1, the information processing apparatus 100 of the present embodiment receives an access request from a terminal (client) 10 through a network 20, such as a local area network (LAN), and controls accesses to storage apparatuses 30A and 30B in accordance with that access request. Access requests include input and output (I/O) requests, such as write requests to the storage apparatuses 30A and 30B and read requests from the storage apparatuses 30A and 30B. The terminal 10 is a computer, such as a personal computer (PC), which uses the storage apparatuses 30A and 30B.

The storage apparatuses 30A and 30B are hierarchical storages utilizing the HSM technique, store files which is accessed by the terminal 10, and include different storage mediums 31 and 32 of two types having different performances, respectively. The storage medium 31 is a relatively faster, smaller-capacity, and expensive primary storage medium, and is an SSD, for example. The storage medium 32 is a relatively slower, larger-capacity, and less expensive secondary storage medium, and is an HDD, for example. The primary storage medium corresponds to a first storage medium, and the secondary storage medium corresponds to a second storage medium.

While the two storage apparatuses 30A and 30B is provided in the example depicted in FIG. 1, three or more storage apparatuses may also be provided. Further, while the storage apparatus 30A is provided with one primary storage medium 31, two or more primary storage mediums 31 may also be provided. Similarly, while the storage apparatus 30B is provided with one secondary storage medium 32, two or more secondary storage mediums 32 may also be provided.

The information processing apparatus 100 includes a metadata server 40 and a data server 50. Each of the metadata server 40 and the data server 50 is a computer, such as a PC.

The metadata server 40 corresponds to a file management unit (file management side) that manages files in the storage apparatuses 30A and 30B and accesses to those files, and manages properties and access information of the files. The metadata server 40 includes at least a processing unit 41 and a storing unit 42, and functions as the file management unit by executing, by the processing unit 41, a program stored in the storing unit 42. The processing unit 41 corresponds to a first processing unit.

The data server 50 corresponds to a storage control unit (storage control side) that controls migrations of the files between the primary storage medium 31 and the secondary storage medium 32, and controls actual data of the files. The data server 50 includes at least a processing unit 51 and a storing unit 52, and the data server 50 functions as the file management unit by executing, by the processing unit 51, a program stored in the storing unit 52. The processing unit 51 corresponds to a second processing unit.

Note that in the present embodiment, the function as the file management unit and the function as the storage control unit are embodied by the processing units 41 and 51 in the separate servers 40 and 50, respectively. The function as the file management unit and the function as the storage control unit, however, may be embodied by a single processing unit in a single server.

The processing units 41 and 51 control the entire servers 40 and 50, respectively. The processing units 41 and 51 may be stand-alone processors or multi-processors. Alternatively, the processing units 41 and 51 may be any of central processing units (CPUs), micro processing units

(MPUs), digital signal processors (DSPs), application specific integrated circuits (ASICs), programmable logic devices (PLDs), and field programmable gate arrays (FPGAs), for example. Alternatively, the processing units 41 and 51 may be combinations of two or more of CPUs, MPUs, DSPs,

ASICs, PLDs, and FPGAs.

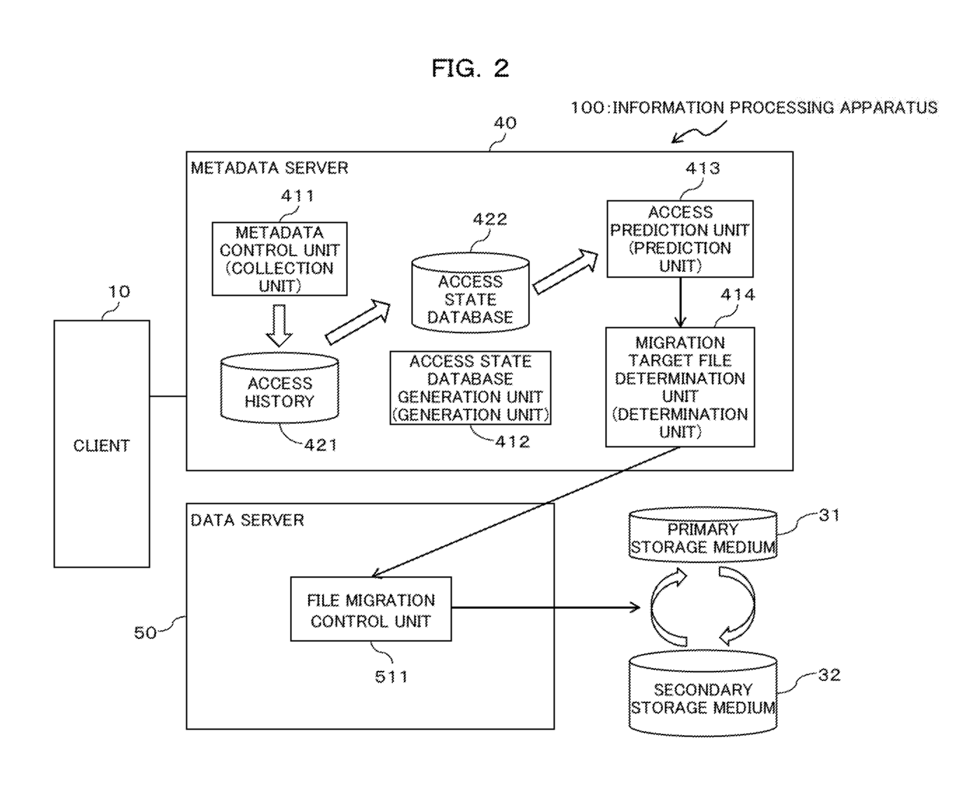

The storing unit 42 stores various types of data that is required for file management processing by the processing unit 41. Such various types of data includes an access history 421 and an access state database 422 that will be described later with reference to FIG. 2, as well as programs, for example. The programs include an operating system (OS) program executed by the processing unit 41 and application programs. The application programs may include storage control programs (not illustrated) including a file management program. The storing unit 42 may be a random access memory (RAM) or an HDD, or may be a semiconductor storage disk (SSD), such as a flush memory.

Similarly, the storing unit 52 stores various types of data that is required for storage control processing by the processing unit 51. Such various types of data includes an OS program executed by the processing unit 51, as well as application programs, for example. The application programs may include a storage control program (not illustrated). The storing unit 52 may be a RAM or an HDD, or may be a semiconductor storage disk (SSD), such as a flush memory.

The programs to be executed by the processing units 41 and 51 may be stored in a non-transitory portable recording medium, such as an optical disk, a memory apparatus, or a memory card. Once the programs stored in the non-transitory portable recording medium are installed in the storing units 42 and 52, they can be executed under the controls of the processing units 41 and 51, for example. Alternatively, the processing units 41 and 51 may read the programs directly from the non-transitory portable recording medium and may execute them.

Here, an optical disk is a portable non-transitory recording medium to which data is recorded so as to be readable with light reflection. Examples of the optical disk include a Blu-ray, a digital versatile disc (DVD), a DVD-RAM, a compact disc read only memory (CD-ROM), and a CD-R (Recordable)/RW (ReWritable). A memory apparatus is a non-transitory recording medium that has a function to communicate with peripheral connecting interfaces (not illustrated), and is a universal serial bus (USB) memory, for example. A memory card is a card-type non-transitory recording medium that is connected to the processing unit 41 or 51 for writing and reading data via a memory reader/writer (not illustrated).

(2) Functional Configuration of Information Processing Apparatus of Present Embodiment

Next, referring to FIGS. 1 and 2, a functional configuration of the information processing apparatus 100 of the present embodiment will be described. FIG. 2 is a block diagram depicting an example of a functional configuration of the information processing apparatus 100 of the present embodiment.

The processing unit 41 in the metadata server 40 functions to determine, from files, a migration target files that is to be migrated from the secondary storage medium 32 to the primary storage medium 31, based on a history 421 of accesses to those files. For that purpose, the processing unit 41 functions as a metadata control unit 411, an access state database generation unit 412, an access prediction unit 413, and a migration target file determination unit 414, which will be described later, by executing the storage control program in the storing unit 42.

The processing unit 51 in the data server 50 functions to cause to migrate the migration target file from the secondary storage medium 32 to the primary storage medium 31. For that purpose, the processing unit 51 functions as a file migration control unit 511 that will be described later by executing the storage control program in the storing unit 52.

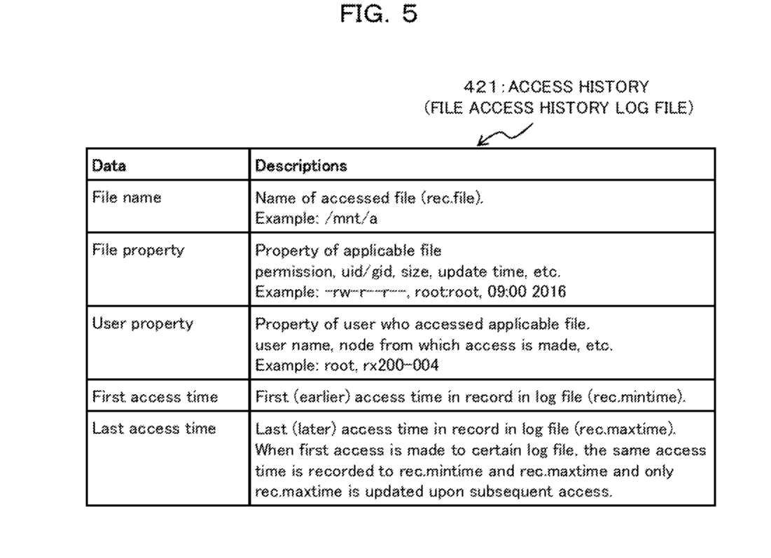

The metadata control unit 411 corresponds to a collection unit that collects states of accesses to the respective files as an access history 421. Specifically, the metadata control unit 411 accepts a file operation (access request) from the client 10, and saves information, such as the file property, in the storing unit 42, as the access history 421. The access history 421 is an accumulation of file access history log files, which will be described later with reference to FIG. 5, for example.

The access state database generation unit 412 corresponds to a generation unit that generates, based on the access history 421, an access state database 422 that associates one access state, with another access state where the one access state transitions to within a predetermined time duration t1.

The access prediction unit 413 corresponds to a prediction unit that obtains, in response to a latest access to a file, another access state that is found by making a search of the access state database 422 for the state of the latest access, as a predicted state where the state of the latest access possibly transitions to within the predetermined time duration t1. Specifically, as will be described later, the access prediction unit 413 extracts a file group that is highly possibly accessed within the predetermined time duration t1 (candidates for a migration target file) based on the access state database 422 after the acceptance of the latest access, when the latest access is accepted by the metadata server 40.

The migration target file determination unit 414 corresponds to a determination unit that determines a migration target file, based on the predicted state obtained by the access prediction unit 413. Specifically, the migration target file determination unit 414 determines a migration target file from the file group (the candidates for a migration target file) extracted by the access prediction unit 413.

The file migration control unit 511 causes to migrate the migration target file determined by the migration target file determination unit 414, from the secondary storage medium 32 to the primary storage medium 31.

Here, one access state described above in the access state database 422 may include first file information that identifies one file to be accessed in that one access state. Further, the other access state described above in the access state database 422 may include second file information that identifies another file to be accessed in the other access state, and the probability of the other file to be accessed within the predetermined time duration t1 after the one file is accessed. Further, the first file information and the second file information may include file names, file properties, user properties, extension information, directory information, node information, and the like.

In this case, the access prediction unit 413 makes a search for the first file information in the access state database 422 with latest file information that identifies a target file to be accessed in the latest access. In this manner, the access prediction unit 413 obtains the second file information and the probability associated with the first file information matching the latest file information, as the predicted state. When the probability is equal to or greater than the first threshold of the second file information and the probability that are obtained, the access prediction unit 413 predicts a file specified by the second file information, as a candidate for a migration target file.

The migration target file determination unit 414 determines a migration target file from the candidates predicted by the access prediction unit 413. In this case, the migration target file determination unit 414 identifies the migration target file from the candidates, based on the degree of improvement in the file access performance in the storage apparatuses 30A and 30B (hierarchical storages). Here, the degree of improvement in the file access performance in the storage apparatuses 30A and 30B is the degree of improvement when the candidates for a migration target file would be migrated from the secondary storage medium 32 to the primary storage medium 31, as compared to when the candidates would not be migrated from the secondary storage medium 32 to the primary storage medium 31. A specific example of the degree of improvement will be described later, and the migration target file determination unit 414 may calculate the degree of improvement for each candidate with a utility function for making a quantitative evaluation. The migration target file determination unit 414 may then determine a candidate of which the degree of improvement calculated with the utility function is equal to or greater than the second threshold as a migration target file.

While the file migration control unit 511 may cause to migrate a file from the primary storage medium 31 to the secondary storage medium 32 in the above-described trigger [a2] in the present embodiment, the file migration control unit 511 may also cause to migrate the file from the primary storage medium 31 to the secondary storage medium 32 in the following trigger in the present embodiment.

Specifically, the file management unit 40 (the processing unit 41) calculates, for each file in the primary storage medium 31, the probability that the file will not be accessed based on information accumulated in the access state database 422. The file management unit 40 (the processing unit 41) then determines a file of which the calculated probability of no access is equal to or greater than a third threshold, as a writeback target file. The storage control unit 50 (the file migration control unit 511 in the processing unit 51) writes the writeback target file determined by the file management unit 40, from the primary storage medium 31 back to the secondary storage medium 32.

(3) Operations of Information Processing Apparatus of the Present Embodiment

(3-1) Overview of Information Processing Apparatus of Present Embodiment

In the present embodiment, an access state (usage state; corresponding to the predicted state) of a file in future after the predetermined time duration t1 elapses from the present time is predicted based on the following input data [b1] and [b2]. Then, based on the result of the prediction, a placement of files is optimized among storage media of multiple types having different performances (e.g., access speeds and capacities), for increasing the throughputs of file accesses in the entire system.

[b1] The “most recent file access state history” during a time period from the past of the predetermined time duration t2 earlier from the present, to the present time, which is classified with “an individual user, a program, and a file property” or “a group of users, programs, and file properties”. The “most recent file access state history” corresponds to a file access history log file that will be described later with reference to FIG. 5, and is collected by the metadata control unit 411.

[b2] A “databased file access state history” that is generated based on the access history 421 that is an accumulation of the “most recent file access state histories” of [b1] described above. The “databased file access state history” corresponds to the access state database 422 generated by the access state database generation unit 412. The “databased file access state history” is made from “pairs of respective file access states for the predetermined time duration t2, and the corresponding file access states of the respective file status after the predetermined time duration t1 elapses”. The “respective file access states for the predetermined time duration t2” correspond to one access state described above. The “corresponding file access states of the respective file status after the predetermined time duration t1 elapses” correspond to another access state described above.

Here, the predetermined time duration t1 is a time duration of the order of several minutes, for example. The predetermined time duration t2 is a time duration sufficiently longer than the predetermined time duration t1, corresponding to a learning period, and is a time duration of the order of about several hours, for example.

In the present embodiment, a hierarchical file system is constructed which includes five components, namely, the metadata control unit 411, the access state database generation unit 412, the access prediction unit 413, the migration target file determination unit 414, and the file migration control unit 511 described above.

The metadata control unit (collection unit) 411 collects and accumulates, every time a latest access is accepted, the state of the latest access as the “most recent file access state history” in the above-described [b1], and obtains the access history 421.

The access state database generation unit (generation unit) 412 generates the “databased file access state history” (refer to the above-described [b2]) as the access state database 422, based on the access history 421 obtained by the metadata control unit 411.

The access prediction unit (prediction unit) 413 predicts a “file access state after the predetermined time duration t1 elapses from the present time (or within the predetermined time duration t1)”, using as inputs, the “databased file access state history” generated by the generation unit 412 and the “most recent file access state history” (i.e., the state of the latest access) collected by the metadata control unit 411. Specifically, the access prediction unit 413 extracts a file group (candidates for a migration target file) that are highly possibly accessed within the predetermined time duration t1, after the acceptance of the latest access, based on the access state database 422.

For the prediction result by the access prediction unit 413 (the candidates for a migration target file), the migration target file determination unit (determination unit) 414 quantifies the “utility” (profits and losses) of a candidate file when the file would be migrated between storage media and as compared to when the file would not be migrated, using a utility function. The “utility” (profits and losses) is equivalent to the degree of improvement described above. The migration target file determination unit 414 then determines a candidate having the degree of improvement calculated with the utility function, which is equal to or greater than the second threshold, as a migration target file.

Specifically, in the present embodiment, the utility obtained when access target files or a set of files classified with the properties would be read ahead is calculated using the utility function (read-ahead utility function). Then the determination as to whether or not a read-ahead is made, based on the predetermined “determination criteria for migrating a file between storage media based on the value of the utility function” (the above-described second threshold).

The file migration control unit 511 causes to migrate the migration target file determined by the determination unit 414, from the secondary storage medium 32 to the primary storage medium 31. As a result, placements of files in the respective storage media in the storage apparatuses 30A and 30B are modified and optimized for increasing the utility as the entire system.

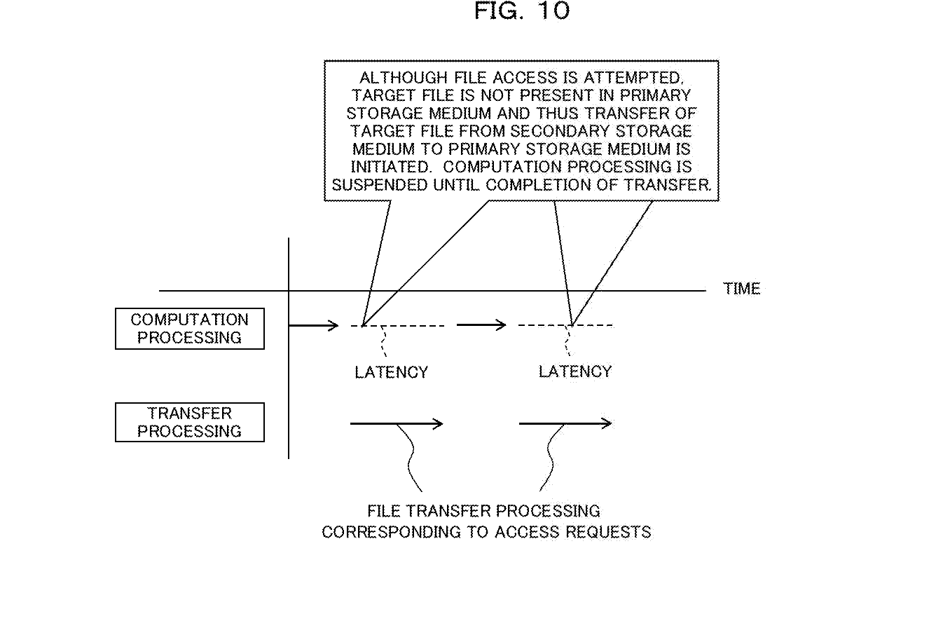

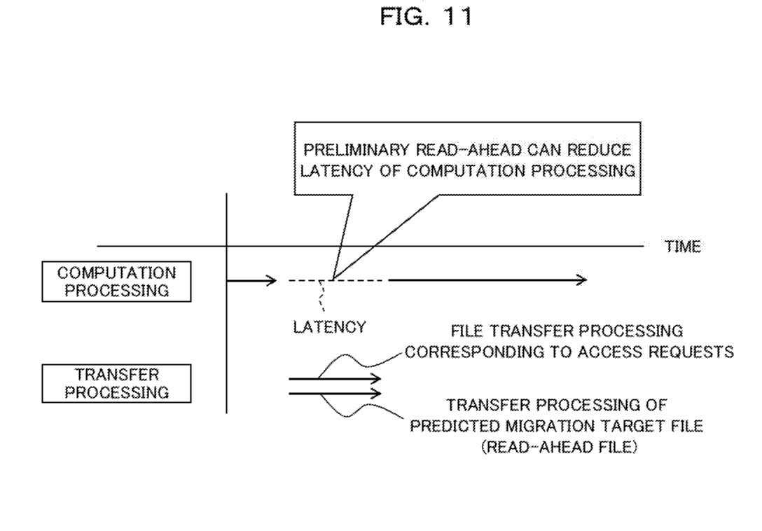

In accordance with the present embodiment, accesses to files can be readily predicted from general access histories, even when detailed information, such as predefined definite schedules, is unavailable. As a result, as depicted in FIG. 11, the predicted file read-ahead from the secondary storage medium 32 to the primary storage medium 31, and the latency of the calculation processing can be reduced as compared to the example depicted in FIG. 10. In other words, file accesses with minimized latencies are achieved on the hierarchical storages.

Therefore, throughputs of file accesses for individual file accesses and execution of programs in the system can be improved, even when predefined definite schedules are unavailable, as compared to the case wherein a file migration is carried out in the on-demand technique (refer to FIG. 10).

FIG. 10 is a diagram illustrating latencies of computation processing experienced in existing techniques. FIG. 11 is a diagram illustrating latencies of computation processing experienced in the present embodiment.

(3-2) Collection Operation of Access History

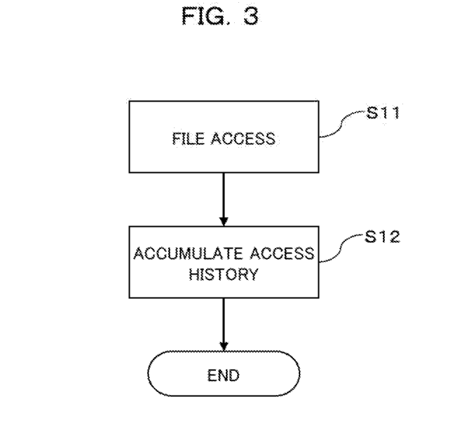

Next, referring to a flowchart depicted in FIG. 3 (Steps S11 and S12), collection and accumulation operations of the access history 421 in the information processing apparatus 100 of the present embodiment will be described.

Every time a file access is received (Step S11), the metadata control unit 411 collects and accumulates the state of that file access, and obtains the access history 421 (Step S12).

Here, as described above in [b1], the obtained access history 421 is an accumulation of the “most recent file access state history” corresponding to file access history log files (refer to FIG. 5) during a time period from the past of the predetermined time duration t2 earlier from the present, to the present time.

(3-3) File Management Operation and Storage Control Operation

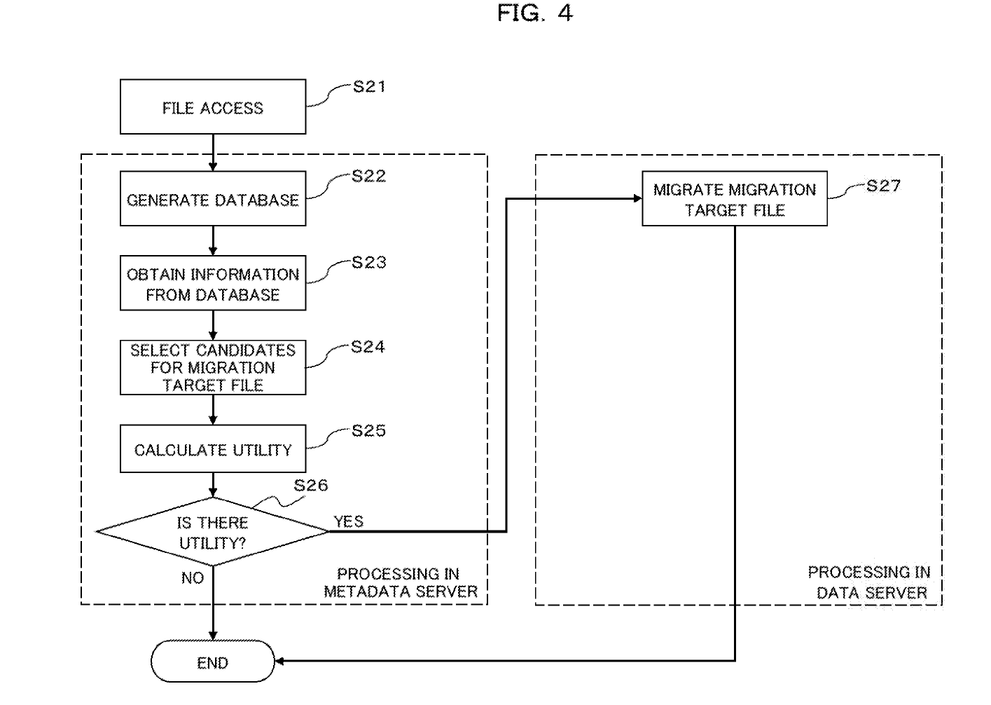

Next, referring to a flowchart depicted in FIG. 4 (Steps S21-S27), a file management operation and a storage control operation in the information processing apparatus 100 of the present embodiment will be described. In FIG. 4, Steps S21-S26 are processing in the metadata server 40 (on the file management side), whereas Step S27 is processing in the data server 50 (on the storage control side).

Every time a file access is received (Step S21), the access state database generation unit 412 generates “databased file access state history” as the access state database 422, based on the accumulated access history 421, (refer to the above-described [b2]) (Step S22).

The access prediction unit 413 then predicts the “file access state after the predetermined time duration t1 elapses from the present time”, using the access state database 422 generated by the generation unit 412, and the state of the latest access collected by the metadata control unit 411 as inputs. Specifically, the access prediction unit 413 obtains information from the access state database 422 (Step S23), and selects a group of files that are highly possibly accessed within the predetermined time duration t1 (i.e., candidates for a migration target file) after the acceptance of the latest access, based on the information (Step S24).

Thereafter, for each of the selected candidates for a migration target file, the migration target file determination unit 414 calculates the utility (degree of improvement) when that candidate would be migrated between storage media and when the file would not be migrated, with a utility function (Step S25). When there is no candidate having a calculated degree of improvement equal to or greater than the second threshold (the NO route from Step S26), the migration target file determination unit 414 ends the processing, without carrying out a file migration.

Otherwise, when there is a candidate with a calculated degree of improvement equal to or greater than the second threshold, the migration target file determination unit 414 determines that candidate having the degree of improvement equal to or greater than the second threshold as a migration target file (the YES route from Step S26). The migration target file determination unit 414 then causes to migrate the migration target file determined by the file migration control unit 511 from the secondary storage medium 32 to the primary storage medium 31 (Step S27).

(3-4) Example of Detailed Operations of the Present Embodiment

Next, referring to FIGS. 5-9, an example of detailed operations of the present embodiment will be described.

In the example of detailed operations described below, a prediction of a file access state and a calculation of the utility of a file migration between storage media are carried out based on the “conditional probability” as described in the following Items [c1] and [c2].

[c1] A database 422 is generated which stores a combination of the file access state (e.g., the count) during a time period from the past of the predetermined time duration t2 earlier from the present, to the present time, and the file access state (e.g., the count) after the predetermined time duration t1 elapses from the present time, based on the “most recent file access state history”, for example. Here, the “most recent file access state history” (refer to the file access history log file in FIG. 5) includes access timing of each file or a group of files by each user or a group of users, and a combination of multiple file properties (e.g., belonging folders and extensions). The access timing is the time duration or time interval from when a file was opened and was then closed, for example. In the present embodiment, a file open information (access time) of each file is accumulated in the database 422, and the “conditional probability” of “file access state after the predetermined time duration t1 elapses from the present time” for a wide variety of cases is determined, based on that database 422.

[c2] The “utility” (degree of improvement) of a file migration is calculated with the utility function, based on the difference between the “file access state at the present time” and the “file access state after the predetermined time duration t1 elapses from the present time” estimated in the above-described [c1]. Then a file migration between storage media (file migration from the secondary storage medium 32 to the primary storage medium 31) is carried out only when the “utility” (the sum or all of the products) is increased in the entire system.

Hereinafter, examples of detailed operations of the present embodiment will be described in more detail.

Based on file access history log files (refer to FIG. 5) classified based on the properties of files and users, the database 422 is generated which stores file access states within the predetermined time duration t1, from file access states based on properties associated with files.

FIG. 5 is a diagram depicting an example of the definition of a record of a file access history log file of the present embodiment, which is accumulated as the access history 421. The file access history log file depicted in FIG. 5 includes the entries of the “file name”, the “file property”, the “user property”, the “first access time”, and the “last access time”.

The “file name” represents the name (rec.file) of a file accessed (access target file), and is/mnt/a, for example.

The “file property” represents the property of an applicable file (access target file) and includes the permission, the uid/gid, the size, the update time, and the like, and is -rw-r--r--, root:root, 09:00 2016, for example.

The “user property” represents the property of a user who has accessed the applicable file (access target file) and includes information, such as the user name, the node from which access has been made, and is root, rx200-004, for example.

The “first access time” represents the first (earlier) access time (rec.mintime) in the record in the log file.

The “last access time” represents the last (later) access time (rec.maxtime) in the record in the log file. When an access is made to a certain log file for the first time, the same access time is recorded (rec.mintime) both to the “first access time” (rec.mintime) and the “last access time” (rec.maxtime). Thereafter, upon subsequent accesses, only the “last access time” (rec.maxtime) is updated.

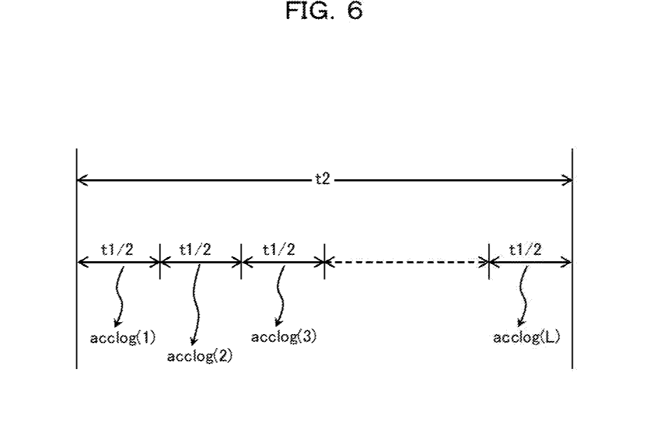

In this case, the access state database 422 is generated as follows. Here, referring to FIGS. 6-9, how the access state database 422 is generated will be described.

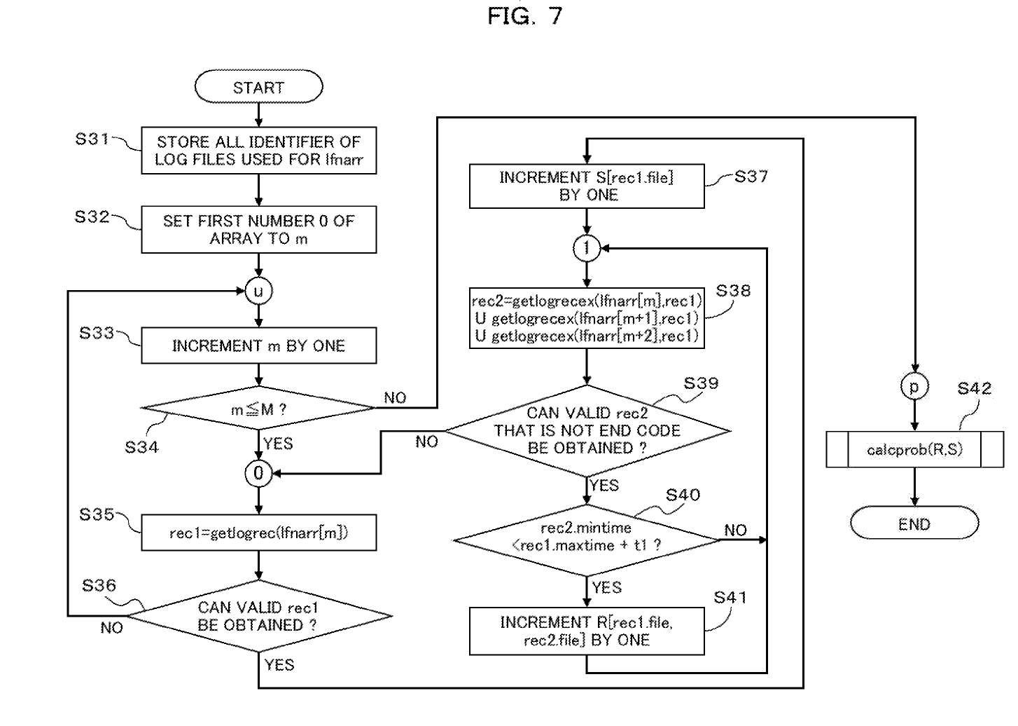

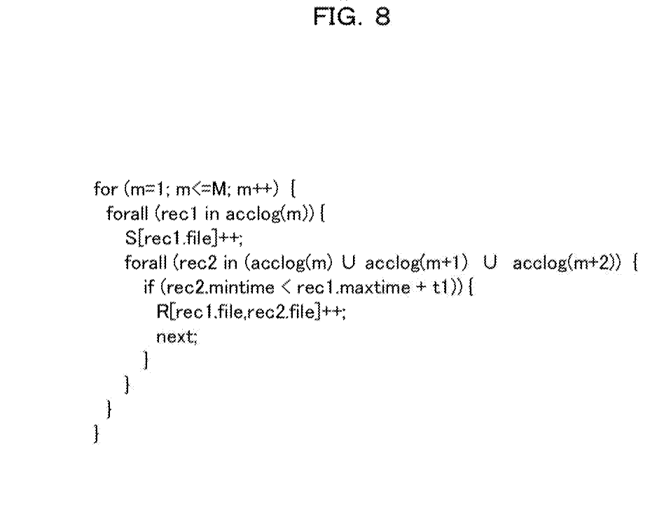

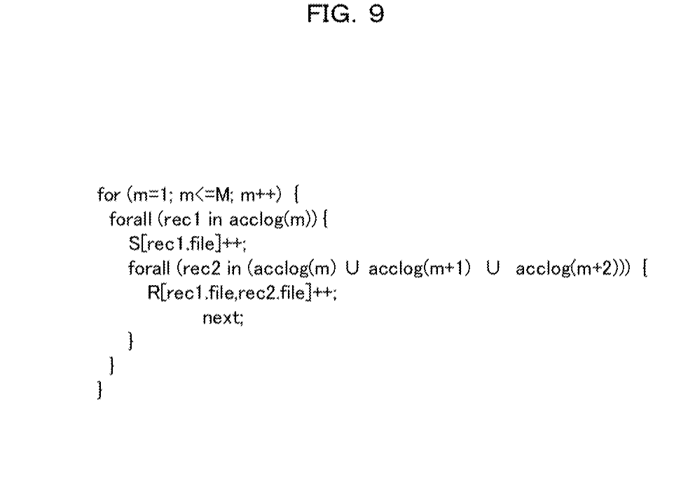

Note that FIG. 6 is a diagram illustrating how the access state database 422 is generated in the present embodiment. FIG. 7 is a flowchart illustrating a generation operation of the access state database 422 in the present embodiment. FIGS. 8 and 9 are diagrams depicting one example and another example of control sentences for calculating access probabilities in the present embodiment, respectively.

Hereinafter, it is assumed that the processing the time duration t1 is sufficiently shorter than the predetermined time duration t2. In addition, a log file of a file access state history is generated at every time interval shorter than the predetermined time duration t1 (e.g., t1/2), and is switched. Each log file have the record format depicted in FIG. 5, and each log file has only one entry for one file. The “access time” in each log file is defined as the time when the file is opened, when the file is read or written, or any of them, for example.

For example, in a generation operation of the database 422, which will be described with reference to the flowchart depicted in FIG. 7, a log file (record) is switched at every time period t1/2, which is a half of the predetermined time duration t1. In the examples of detailed operations described therein, as depicted in FIG. 6, multiple (L in FIG. 6) log files, namely, record acclog(1), acclog(2), acclog(3), . . . , and acclog(L), are generated in the respective time intervals.

Specifically, in the present embodiment, a single record as defined in FIG. 5 is generated for one file. Then, as depicted in FIG. 6, a file access state history during the past period of the predetermined time duration t2 are retained separately in multiple log files (i.e., acclog(1), acclog(2), acclog(3), . . . , and acclog(L)). Such a record format is advantageous in that increases in sizes of log files are suppressed.

Other than the parameters used in the log record described above, the following variables are used in a flowchart depicted in FIG. 7, and control sentences in described in FIGS. 8 and 9:

lfnarr[ ]: An array for storing identifiers of used log files.

M: The total count of used log files (e.g., 2).

m: The counter variable for used log files.

S[file]: an associative array of the total access count corresponding to a specified file. An element containing no data (corresponding to file) indicates “no access”.

R[file1, file2]: An associative array of the access count of file2 (another file) within the predetermined time duration t1 after file1 (one file) is accessed. An element containing no data (corresponding to a pair of files) indicates “no access”.

Prob[file1, file2]: An associative array of the probability file2 (another file) within the predetermined time duration t1 after file1 (one file) is accessed. An element containing no data (corresponding to a pair of files) is handled as a probability 0.

Note that associative arrays are data types, from which all of stored elements can be sequentially obtained, and are available in a number of program languages, such as awk, Perl, and Python. Since pairs of files where “another file is accessed within the predetermined time duration t1 after a certain file was accessed” are rare, associative arrays are used for the purpose of “recording such pairs in logs” for effectively utilizating storage areas.

Here, logfiles are file access history log files defined as in FIG. 5, and exclude_file represents the file name, and rec1 and rec2 are records of the respective file access history log files. file* is a variable (file name) representing generalized file names for describing the functions of the program, and rec*.file is a file name of an element of the record.

Since it is apparent that the following functions are available as built-in functions in a number of program languages, descriptions of how to implement them are omitted and only the functionalities thereof will be described.

getlogrec(logfile): This function is used to obtain the “next access record” from the log file. An end code is returned when the end of the file is reached.

getlogrecex(logfile, exclude_file): This function is used to obtain the next access record to a file other than exclude file from the log file. An end code is returned when the end of the file is reached.

calcprob(R, S): This function calculates the probabilities for all of stored elements in the associative array R using the following equation:

Prob[file1, file2]=R[file1, file2]/S[file1]

Here, what is important is the processing to provide the associative arrays R and S, which are the inputs to calcprob(R, S). It can be regarded that the processing as described in FIG. 8 is executed in the pseudo codes, for example. Here, a hypothetical language is assumed which can handle sets as data, and the operator “∪” represents the union. Note that the sentence “next;” is a control sentence not to count the same record rec2 delicately.

Here, referring to the flowchart depicted in FIG. 7 (Steps S31-S42), a generation operation of the access state database 422 will be described briefly, with reference to the control sentences described in FIG. 8.

Initially, all identifiers of log files used are stored in lfnarr (Step S31), and the counter variable m is set to the initial number 0 of the array (Step S32). Thereafter, m is incremented by one (Step S33), and it is determined whether or not m·M holds true (Step S34). When m·M does not hold true, or when m>M holds true (the NO route from Step S34), the processing transitions to Step S42. In Step S42, the probability Prob[file1, file2]=R[file1, file2]/S[file1] is calculated by calcprob(R, S) for all of the stored elements in the associative array R. These probabilities are equivalent to the probabilities that the other file file2 is accessed after the one file file1 is accessed within the predetermined time duration t1.

Otherwise, when m·M holds true (the YES route from Step S34), the record of acclog(m) is obtained (Step S35). The “forall (rec1 in acclog(m)) {” described in FIG. 8 is equivalent to the processing rec1=getlogrec(lfnarr[m]) in Step S35 in FIG. 7.

When no valid record rec1 is obtained (the NO route from Step S36), the processing transitions to Step S33. Otherwise, when a valid record rec1 is obtained (the YES route from Step S36), the associative array S[rec1.file] is incremented by one (Step S37). The “S[rec1.file]++” described in FIG. 8 is equivalent to the processing in Step S37 in FIG. 7. In other words, the counter for counting how many times the file with the name rec1.file has been accessed is incremented.

Then, “rec2 in (acclog(m)∪acclog(m+1)∪acclog(m+2))” described in FIG. 8 is equivalent to the processing rec2=(getlogrecex(lfnarr[m], rec1)∪getlogrecex(lfnarr[m+1], rec1)∪getlogrecex(lfnarr[m+2], rec1)) in Step S38 in FIG. 7. Since a log file is switched at every time period t1/2, which is a half of the predetermined time duration t1 in this example, a group of record files that may probably have been accessed within the predetermined time duration t1 after the file of the record rec1 obtained in Step S35 was accessed.

Then, when valid record rec2 that is not the end code is be obtained (the NO route fromStep S39), the processing transitions to Step S35. Otherwise, when valid record rec2 that is not the end code is obtained (the YES route from Step S39), a determination of rec2.mintime<rec1.maxtime+t1 is made (Step S40). The “if (rec2.mintime<rec1.maxtime+t1)” described in FIG. 8 is equivalent to the above determination in Step S39 in FIG. 7. When rec2.mintime<rec1.maxtime+t1 does not hold true (the NO route from Step S40), the processing transitions to Step S38.

Otherwise, when rec2.mintime<rec1.maxtime+t1 holds true (the YES route from Step S40), the access count of file that was actually accessed is incremented by one within the predetermined time duration t1 by incrementing the associative array R[rec1.file, rec2.file] by one (Step S41) and then the processing transitions to Step S38. The “R[rec1.file, rec2.file]++” described in FIG. 8 is equivalent to the processing in Step S41 in FIG. 7.

In the meantime, the time duration t1 is used as a “measure” to make a determination as to whether an access to another file occurs ‘during not a long time period elapses’ after an access to a certain file occurred”. Therefore, since a determination of “within the predetermined time duration t1” is not necessarily strictly determined for the purpose of the control, it is possible to reduce the size of the recorded data by eliminating time durations from records of a “log file generated at every time interval” described above. This modification will be described as a supplementary.

In the flowchart depicted in FIG. 7, the identifiers of acclog(m), acclog(m+1), and acclog(m+2) are stored in the arrays lfnarr[m], lfnarr[m+1], and lfnarr[m+1], respectively. However, rec.mintime and rec.maxtime are used only when the relationship between the file in the array lfnarr[m] and the file in the array lfnarr[m+2] is checked. The reason why rec.mintime and rec.maxtime are used when the relationship between the file in the array lfnarr[m] and the file in the array lfnarr[m+2] is checked is to make a strict determination as to within the predetermined time duration t1. Therefore, when an error of 1.5 time of the predetermined time duration t1 can be tolerated, neither rec.mintime nor rec.maxtime may not be used or recorded. In this case, as described in FIG. 9, it is possible to delete the “if” sentence from the control sentences described in FIG. 8 and the processing time can be reduced.

While a log file is switched at every time period t1/2, which is a half of the predetermined time duration t1 in the above-described example, the present invention is not limited to this example. For example, any error of access predictions and the like can be reduced further when a log file is switched at every time period t1/k (k is an integer of 3 or greater), which is one k^{th} of the predetermined time duration t1.

While the procedure to generate a database has been described for files with the same file identifier in the above-described example, the following properties may be used as properties associated with files.
Directories (the same directory or directories under a common parent directory)
Users (the same user, the same group)
Program-related properties (files having a common extension)
Nodes (nodes from which an access is made)

The probability that another file is accessed within the predetermined time duration t1 after one file was accessed is estimated based on a conditional probability in the above-described example. A probability of a combination of multiple conditions may be calculated in accordance with the definition of conditional probabilities using the Bayesian theory, or may be estimated using the Naive Bayes technique that assumes that all of events related to the combination of conditions are independent, for simplifying the calculation. The Naive Bayes technique will be described in a second concrete example of operations.

(4) Examples of Specific Operations

(4-1) First Example of Operations

A first concrete example of operations of the information processing apparatus 100 of the present embodiment will be described.

In the first example of operations, the following phenomena A(d, f, t) are assumed as file access anticipating phenomena, from the access history 241.

A(d, f, t): A phenomenon in which a file f under a certain directory d is accessed during the time duration t.

In addition, in the first example of operations, the following files S(A) is used as an evaluation target file group.

S(A): “Files in the same directory” and “files having the same file extension in directories under a common parent directory”.

In this case, the access probabilities of respective files belonging to the evaluation target file group S(A) are obtained (calculated) from the access state database 422.

When an obtained access probability is equal to or greater than a certain threshold, data is migrated from the secondary storage medium 32 to the primary storage medium 31.

The first threshold (or second threshold) described above may be used as the threshold as used herein.

(4-2) Second Example of Operations

A second concrete example of operations of the information processing apparatus 100 of the present embodiment will be described.

In the second example of operations, access history used for an access prediction is enhanced in order to enhance the accuracy of the access prediction. The access history used will be described.

[d1] File Access Anticipating Phenomena

The following phenomena A-D are used as the “lfile access anticipating phenomena”.

A(d, f, t): A phenomenon in which a file f under a certain directory d is accessed during a time duration t.

B(u, f, t): A phenomenon in which a file f of a certain user u is accessed during a time duration t.

C(p, f, t): A phenomenon in which a file f of a program p is accessed in a certain node n during a time duration t.

D(n, u, f, t): A phenomenon in which a file f under a certain directory d is accessed by a user u during a time duration t.

[d2] Evaluation Target File Groups

The evaluation target file groups in the above-described file access anticipating the phenomena A-D are referred to as S(A), S(B), S(C), and S(D), respectively. Here, for each of the file access anticipating phenomena A-D, files that may have been accessed within the predetermined time duration t1 with a probability equal to or greater than a predetermined value (first threshold) and satisfy the following conditions are defiled in advance for “evaluation target file groups” from access history.

S(A): “Files in the same directory” and “files having the same file extension in directories under a common parent directory”.

S(B): “Files owned by a user u” and “files of users belonging to the same group as that of the user u, to which access permission is given to the user u”

S(C): “Files having the same file extension to be accessed by a program p”

S(D): “Files to be accessed by a user u from a node n”

[d3] Access Probability within the Predetermined Time Duration

The “access probabilities within the predetermined time duration” of a certain file are recorded for files belonging to the evaluation target file groups S(A)-S(D). A “access probability within the predetermined time duration” is calculated as a ratio of the access count of a file accessed within the predetermined time duration t1 after a certain time was accessed, to the access count to that certain file. The “access probability within the predetermined time duration” may be stored for each file. Alternatively, the “access probability within the predetermined time duration” may be stored for each of subset of groups, for the purpose of reducing the data size to be referenced to. Here, a subset of groups may be a subset of files having file name lengths shorter than X, a subset of files having file name lengths not shorter than X, a subset of files having file sizes smaller than Y, or a subset of files having file sizes not smaller than Y. Note that the “access probability within the predetermined time duration” may be updated every time an access request is made, or may not be updated after a certain learning period, instead of updating upon every access request.

In the present embodiment, for calculating the probability corresponding to multiple anticipating events (e.g., S(A)∩S(B)), the Naive Bayes technique is used which regards complementary events as independent. Specifically, when it is assumed that the probability that x∈S(A) is accessed within the predetermined time duration t1 is p and the probability that y∈S(B) is accessed within the predetermined time duration t1 is q, the probability that z∈S(A)∩S(B) is accessed within the predetermined time duration t1 is estimated as 1−(1−p) (1−q).

In this case, the access probability P(e) can be determined for all e∈S(A)∪S(B)∪S(C)∪S(D) as follows. In the following cases, it is assumed that the probability that x′∈S(C) is accessed within the predetermined time duration t1 is r, and the probability that y′∈S(D) is accessed within the predetermined time duration t1 accessed is s.

Case 1: When a file e belongs to one of S(A), S(B), S(C), and S(D), the probability in the belonging “evaluation target file group” (one of probabilities p, q, r, and s) is associated with e.

Case 2: When a file e belongs to two of S(A), S(B), S(C), and S(D), the probability 1−(1−p) (1−q) is associated with e if it is assumed that the probabilities in the two “evaluation target file groups” are p, q.

Case 3: When a file e belongs to three of S(A), S(B), S(C), and S(D), the probability 1−(1−p) (1−q) (1−r) is associated with e if it is assumed that the probabilities in the three “evaluation target file groups” are p, q, r.

Case 4: When a file e belongs to all of S(A), S(B), S(C), and S(D), the probability 1−(1−p) (1−q) (1−r) (1−s) is associated with e.

In addition, for quantitatively evaluating the utility of reading-ahead a file, in the present embodiment, a “read-ahead utility function” is determined in any one of the following [e1]-[e3] for the above-described file e, for example.

[e1] The probability per se of being accessed within the predetermined time duration t1

[e2]The predicted value of the transfer time (transfer latency) based on the file size

[e3] The difference in the processing time which is actually obtained. Specifically, the actual value of the difference between the processing time when a file was accessed from the secondary storage medium 32 without reading-ahead the file, and the processing time when the file was read-ahead and was accessed from the primary storage medium 31, and the difference is set as a function of the file e.

The criterion for a determination as to whether to carry out a read-ahead (a file migration from the secondary storage medium 32 to the primary storage medium 31) include the following [f1] and [f2] , for example.

[f1] When the value obtained by applying the “read-ahead utility function” to the above-described file e is equal to or greater than a predetermined threshold (second threshold), the file of interest is read-ahead to the primary storage medium 31. It is considered that the predetermined threshold may be modified dynamically depending on the free space in the primary storage medium 31.

[f2] Predetermined number of files are read-ahead to the primary storage medium 31 in the descending order of the values obtained by applying the “read-ahead utility function” to the above-described file e. It is considered that the predetermined number may be modified dynamically depending on the free space in the primary storage medium 31.

(4-3) Third Example of Operations

A third concrete example of operations of the information processing apparatus 100 of the present embodiment will be described.

The free space in the primary storage medium 31 may be smaller than a predetermined threshold (fourth threshold), or the degree of fragmentation of the primary storage medium 31 is equal to or greater than the predetermined threshold (fifth threshold). In such a case, it may be desirable to eliminate the fragmentation by evacuating a part of files in the primary storage medium 31 to the secondary storage medium 32 and then reading them back to the primary storage medium 31.

In such a case, in the third example of operations, in addition to the operations in the above-described first example of operations, the probability that a file is not accessed is calculated for each file in the primary storage medium 31, based on information accumulated in the access state database 422. A file having the calculated probability of not being accessed are equal to or greater than the third threshold are determined as a writeback target filed, and that writeback target file is written from the primary storage medium 31 back to the secondary storage medium 32.

As a result, it is possible to increase the free area in the primary storage medium 31, and it is possible to carry out the read-ahead processing more aggressively. In addition, it is ensured that a fragmentation is eliminated by reading files back to the primary storage medium 31.

Accesses to files can be readily predicted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus comprising:
a memory; and
a first processor and a second processor coupled to the memory and the first processor configured to:
manage files in a storage apparatus and accesses to the files; and
determine a migration target file from the files based on a history of the accesses to the files, the migration target file being to be migrated from a second storage medium to a first storage medium in the storage apparatus, the first and second storage mediums having different performances, and
the second processor configured to:
control migrations of the files between the first storage medium and the second storage medium; and
migrate the migration target file from the second storage medium to the first storage medium.

2. The information processing apparatus according to claim 1, wherein
the first processing unit is configured to:
collect states of the accesses to the files as the history;
generate an access state database based on the history, the access state database associating one access state, with another access state where the one access state transitions to within a predetermined time duration;
obtain, in response to a latest access to a file of the files, the other access state that is obtained by making a search in the access state database with a state of the latest access, as a predicted state where the state of the latest access possibly transitions to within the predetermined time duration; and
determine the migration target file from the files based on the predicted state, and
the second processing unit is configured to cause the migration target file determined by the first processing unit to be migrated from the second storage medium to the first storage medium migration.

3. The information processing apparatus according to claim 2, wherein
the one access state includes first file information that specifies one file to be accessed in the one access state,
the other access state includes second file information that specifies another file to be accessed in the other access state, and a probability of the other file to be accessed within the predetermined time duration after the one file is accessed, and
the first processing unit is configured to:
obtain, by making a search in the access state database for the first file information with latest file information that specifies a file to be accessed in the latest access, the second file information and the probability that are associated with the first file information matching the latest file information, as the predicted state;
predict files specified by the second file information as candidates for the migration target file, when the probability is equal to or greater than a first threshold with regard to the second file information and the probability that are obtained; and
determine the migration target file from the predicted candidates.

4. The information processing apparatus according to claim 3, wherein the first processing unit is configured to determine the migration target file from the predicted candidates, based on a degree of improvement in a file access performance of the storage apparatus when the candidates would be migrated from the second storage medium to the first storage medium, as compared to when the candidates would not be migrated from the second storage medium to the first storage medium.

5. The information processing apparatus according to claim 4, wherein the first processing unit is configured to:
calculate the degree of improvement for each candidate with a utility function for making a quantitative evaluation; and
determine a candidate among the candidates which has the degree of improvement calculated with the utility function is equal to or greater than a second threshold, as the migration target file.

6. The information processing apparatus according to claim 2, wherein the first processing unit is configured to:
calculate, for each file in the first storage medium, a probability of that file not being accessed, based on information accumulated in the access state database; and
determine a file with the calculated probability of not being accessed is equal to or greater than a third threshold, as writeback target file, and
the second processing unit is configured to write the writeback target file from the first storage medium back to the second storage medium.

7. A non-transitory computer-readable recording medium having a storage control program stored therein,
the storage control program making a first processing unit execute processing to:
manage files in a storage apparatus and accesses to the files; and
determine a migration target file from the files based on a history of the accesses to the files, the migration target file being to be migrated from a second storage medium to a first storage medium in the storage apparatus, the first and second storage mediums having different performances, and
the storage control program making a second processing unit execute processing to:
control migrations of the files between the first storage medium and the second storage medium; and
migrate the migration target file from the second storage medium to the first storage medium.

8. The non-transitory computer-readable recording medium according to claim 7, wherein
the storage control program makes the first processing unit execute processing to:
collect states of the accesses to the files as the history;
generate an access state database based on the history, the access state database associating one access state, with another access state where the one access state transitions to within a predetermined time duration;
obtain, in response to a latest access to a file of the files, the other access state that is obtained by making a search in the access state database with a state of the latest access, as a predicted state where the state of the latest access possibly transitions to within the predetermined time duration; and
determine the migration target file from the files based on the predicted state, and
the storage control program makes the second processing unit execute processing to cause the migration target file determined by the first processing unit to be migrated from the second storage medium to the first storage medium migration.

9. The non-transitory computer-readable recording medium according to claim 8, wherein
the one access state includes first file information that specifies one file to be accessed in the one access state,
the other access state includes second file information that specifies another file to be accessed in the other access state, and a probability of the other file to be accessed within the predetermined time duration after the one file is accessed, and
the storage control program makes the first processing unit execute processing to:
obtain, by making a search in the access state database for the first file information with latest file information that specifies a file to be accessed in the latest access, the second file information and the probability that are associated with the first file information matching the latest file information, as the predicted state;
predict files specified by the second file information as candidates for the migration target file, when the probability is equal to or greater than a first threshold with regard to the second file information and the probability that are obtained; and
determine the migration target file from the predicted candidates.

10. The non-transitory computer-readable recording medium according to claim 9, wherein the storage control program makes the first processing unit execute processing to determine the migration target file from the predicted candidates, based on a degree of improvement in a file access performance of the storage apparatus when the candidates would be migrated from the second storage medium to the first storage medium, as compared to when the candidates would not be migrated from the second storage medium to the first storage medium.

11. The non-transitory computer-readable recording medium according to claim 10, wherein the storage control program makes the first processing unit execute processing to:
calculate the degree of improvement for each candidate with a utility function for making a quantitative evaluation; and
determine a candidate among the candidates which has the degree of improvement calculated with the utility function is equal to or greater than a second threshold, as the migration target file.

12. The non-transitory computer-readable recording medium according to claim 8, wherein the storage control program makes the first processing unit execute processing to:
calculate, for each file in the first storage medium, a probability of that file not being accessed, based on information accumulated in the access state database; and
determine a file with the calculated probability of not being accessed is equal to or greater than a third threshold, as writeback target file, and
the storage control program makes the second processing unit execute processing to write the writeback target file from the first storage medium back to the second storage medium.

13. A method of controlling a storage, the method comprising:
by a first processing unit,
managing files in a storage apparatus and accesses to the files; and
determining a migration target file from the files based on a history of the accesses to the files, the migration target file being to be migrated from a second storage medium to a first storage medium in the storage apparatus, the first and second storage mediums having different performances, and
by a second processing unit,
controlling migrations of the files between the first storage medium and the second storage medium; and
migrating the migration target file from the second storage medium to the first storage medium.

14. The method according to claim 13, further comprising
by the first processing unit,
collecting states of the accesses to the files as the history;
generating an access state database based on the history, the access state database associating one access state, with another access state where the one access state transitions to within a predetermined time duration;
obtaining, in response to a latest access to a file of the files, the other access state that is obtained by making a search in the access state database with a state of the latest access, as a predicted state where the state of the latest access possibly transitions to within the predetermined time duration; and
determining the migration target file from the files based on the predicted state, and
by the second processing unit,
causing the migration target file determined by the first processing unit to be migrated from the second storage medium to the first storage medium migration.

15. The method according to claim 14, wherein
the one access state includes first file information that specifies one file to be accessed in the one access state,
the other access state includes second file information that specifies another file to be accessed in the other access state, and a probability of the other file to be accessed within the predetermined time duration after the one file is accessed, and
the method further comprises:
by the first processing unit,
obtaining, by making a search in the access state database for the first file information with latest file information that specifies a file to be accessed in the latest access, the second file information and the probability that are associated with the first file information matching the latest file information, as the predicted state;
predicting files specified by the second file information as candidates for the migration target file, when the probability is equal to or greater than a first threshold with regard to the second file information and the probability that are obtained; and
determining the migration target file from the predicted candidates.

16. The method according to claim 15, further comprising, by the first processing unit, determining the migration target file from the predicted candidates, based on a degree of improvement in a file access performance of the storage apparatus when the candidates would be migrated from the second storage medium to the first storage medium, as compared to when the candidates would not be migrated from the second storage medium to the first storage medium.

17. The method according to claim 16, further comprising:
by the first processing unit,
calculating the degree of improvement for each candidate with a utility function for making a quantitative evaluation; and
determining a candidate among the candidates which has the degree of improvement calculated with the utility function is equal to or greater than a second threshold, as the migration target file.

18. The method according to claim 14, further comprising
by the first processing unit,
calculating, for each file in the first storage medium, a probability of that file not being accessed, based on information accumulated in the access state database; and
determining a file with the calculated probability of not being accessed is equal to or greater than a third threshold, as writeback target file, and
by the second processing unit, writing the writeback target file from the first storage medium back to the second storage medium.
